(19) United States
(12) Patent Application Publication
(10) Pub. No.: US 2022/0254207 A1
(43) Pub. Date: Aug. 11, 2022

(54) METHOD AND MEANS FOR REMOTELY CONTROLLING A SECURE FUNCTION OF A MOTOR VEHICLE BY MEANS OF A MOBILE COMMUNICATION TERMINAL

(71) Applicant: Continental Automotive GmbH, Hannover (DE)

(72) Inventors: Stéphane Billy, Toulouse (FR); Sylvain Godet, Toulouse (FR); Jérôme Lee, Toulouse (FR)

(21) Appl. No.: 17/616,424

(22) PCT Filed: Jun. 19, 2020
(86) PCT No.: PCT/EP2020/067213

§ 371 Date: Dec. 3, 2021

(30) Foreign Application Priority Data
Jun. 27, 2019 (FR) FR1907006

(51) Int. Cl. G07C 9/00; G08C 17/02

(52) U.S. Cl. CPC G07C 9/00309; G07C 2009/00507; G07C 2209/63; G08C 17/02

(57) ABSTRACT

A method for the remote control, by way of a mobile communication terminal equipped with a UHF-SHF module, of a secure motor vehicle function requiring a user to be present within a security perimeter around the vehicle, the vehicle being equipped with an access device including a control unit and an access fob. The method includes: detecting the presence of the access fob within the security perimeter around the vehicle through LF transmission between the vehicle and the access fob; detecting the presence of the mobile communication terminal at a distance less than a predetermined distance from the access fob, through a communication operation between the access fob and the mobile communication terminal; remotely controlling, by way of the mobile communication terminal, the secure function of the vehicle on the UHF-SHF frequency band.

### CROSS REFERENCE TO RELATED APPLICATIONS

This application is the U.S. National Phase Application of PCT International Application No. PCT/EP2020/067213, filed Jun. 19, 2020, which claims priority to French Patent Application No. 1907006, filed Jun. 27, 2019, the contents of such applications being incorporated by reference herein.

### FIELD OF THE INVENTION

The invention belongs to the automotive field and relates to a method and to means for the remote control, by way of a mobile communication terminal, of a secure motor vehicle function requiring a user to be present within a security perimeter around the vehicle.

### BACKGROUND OF THE INVENTION

Some functions of a motor vehicle, which are able to be controlled remotely, constitute a risk if the user is not close to the vehicle in order to supervise this remote control. This is the case for example for remote parking functions that are available in some modern vehicles. In vehicles equipped with such a remote parking system, the driver is able to leave the vehicle and remotely control the parking of the vehicle using his multifunction mobile telephone. This system is useful for example for parking a vehicle in a tight space that does not allow the driver's door to be opened once the vehicle has been parked. The user thus brings his vehicle as close as possible to this tight space, and then leaves the vehicle and remotely controls the vehicle for a few meters, allowing it to be parked in the tight space. During the remote control, there is no driver in the vehicle passenger compartment and, for security reasons, the user has to be in the immediate vicinity of the vehicle while performing the remote control, with the same care as if he were behind the wheel.

Such methods for the remote control of a secure function of the vehicle require strict monitoring of the presence of the user within a defined security perimeter around the vehicle, this involving the need to reliably detect the distance of the user from the vehicle during the remote control operations.

### PRIOR ART

There are currently various systems for the remote control of a secure function that require a user to be present within a security perimeter around a motor vehicle.

There are for example some systems for remotely controlling the parking of a vehicle using a mobile communication terminal such as a multifunction mobile telephone (or “smartphone”), or a connected watch. These systems use for example the “Bluetooth” or “Bluetooth Low Energy” (BLE) communication standard so that the user's mobile communicates with the vehicle and remotely controls the parking function. Estimating the distance between the user's mobile and the vehicle makes it possible to determine whether the user carrying the mobile is actually within the security perimeter around the vehicle.

These systems are very ergonomic, since they allow the user to use his own mobile telephone. However, the Bluetooth communication standard, along with other communication standards available in multifunction mobile telephones, operate on the UHF (“Ultra High Frequency”) frequency bands, the frequencies of which are between 300 MHz and 3 GHz, or SHF (“Super High Frequency”) frequency bands, the frequencies of which are between 3 GHz and 30 GHz. UHF and SHF signals have a relatively long range (up to several tens of meters for the BLE standard, for example), but do not allow a device to be located accurately. Specifically, the distance between the mobile terminal and the vehicle is estimated on the basis of a received power level of a message transmitted by the mobile terminal, through the measurement of the RSSI (“Received Signal Strength Indicator”) at the vehicle. The higher the RSSI, the more the mobile terminal is located in an area close to the vehicle. By contrast, the lower the RSSI, the more the mobile terminal is located in an area far away from the vehicle. The RSSI measurement of a UHF signal is unstable since it may vary significantly depending on the environment (humidity, obstacle, interference, etc.).

The estimate of the position of the mobile terminal with respect to the vehicle is therefore inaccurate when using a bidirectional UHF or SHF radio link, which is unacceptable in the case of the remote control of a secure motor vehicle function, which has to imperatively and reliably detect the presence of the user within a security perimeter around the vehicle.

Other systems for the remote control of a secure vehicle function overcome this problem by providing hardware dedicated to this remote control. The vehicle is thus supplied with a remote control device that, in addition to providing any other functions, makes it possible to remotely control a secure function, such as remote parking. The distance between the vehicle and the user carrying the control device is estimated by this dedicated hardware. The solution is thus not limited by the technologies that are necessarily available in a mobile communication terminal, and other more efficient technologies for estimating distances may be implemented. These systems are thus satisfactory from the point of view of security, but lead to a significant loss of ergonomics insofar as the user is not able to use his own mobile communication terminal to remotely control the secure function. Additional costs are also brought about by this additional hardware dedicated to remote control.

### SUMMARY OF THE INVENTION

An aspect of the invention aims to improve systems for the remote control of a secure motor vehicle function from the prior art.

To this end, an aspect of the invention targets a method for the remote control, by way of a mobile communication terminal equipped with a UHF-SHF module, of a secure motor vehicle function requiring a user to be present within a security perimeter around the vehicle, this vehicle being equipped with an access device comprising a control unit and an access fob, this method comprising the following steps:
detecting the presence of the access fob within said security perimeter around the vehicle through LF communication between the vehicle and the access fob;
detecting the presence of the mobile communication terminal at a distance less than a predetermined distance from the access fob, through a communication operation between the access fob and the mobile communication terminal;
remotely controlling, by way of the mobile communication terminal, said secure function of the vehicle on the UHF-SHF frequency band.

Another aspect of the invention targets a device for the remote control of a secure motor vehicle function according to the method described above, this device comprising:
a vehicle control unit designed to control access to the vehicle and comprising an LF transmitter and a UHF-SHF transceiver;
an access fob equipped with an LF receiver and designed to communicate with the vehicle control unit in order to remotely control access to the vehicle;
a mobile communication terminal equipped with a UHF-SHF module designed to communicate with the UHF-SHF transceiver of the vehicle control unit in order to remotely control said secure function of the vehicle;

the vehicle control unit comprising detection means for detecting the presence of the access fob within said security perimeter around the vehicle;

the access fob comprising detection means for detecting the presence of the mobile communication terminal at a distance less than said predetermined distance.

Another aspect of the invention targets an LF vehicle access fob designed to implement the method described above, and comprising communication means for communicating with a mobile communication terminal.

Another aspect of the invention targets an application for a mobile communication terminal, comprising instructions that, when the application is executed by a mobile communication terminal, prompt the latter to implement the following steps:
provide an interface for the remote control of a secure motor vehicle function requiring a user to be present within a security perimeter around the vehicle;
periodically generate a flashing sequence on a component of the mobile communication terminal.

In the present description and in the claims, the LF transceiver and the LF communication are defined as relating to a radio link using electromagnetic waves the frequencies of which are between 30 kHz and 300 kHz (LF or “Low Frequency” radio waves).

In the present description and in the claims, the expressions “UHF-SHF module” and “UHF-SHF transceiver” denote radio wave transceivers able to transmit and receive radio signals at a frequency within the UHF (“Ultra High Frequency”) radiofrequency band or in the SHF (“Super High Frequency”) frequency band. The UHF radiofrequency band is the band of the radio spectrum between 300 MHz and 3 GHz, and the SHF radiofrequency band is the band of the radio spectrum between 3 GHz and 30 GHz. A UHF-SHF transceiver module is therefore designed to transmit and receive at a frequency of between 300 MHz and 30 GHz. Such UHF-SHF modules may for example be modules conforming to the Bluetooth standard or to the Wi-Fi standard.

Such remote control of a secure vehicle function makes it possible to perform both the remote control operation and the operation of monitoring the presence of the user within the security perimeter in an optimum manner.

The monitoring of the distance between the user and the vehicle, which makes it possible to ensure the presence of the user within the security perimeter around the vehicle, is carried out by the access fob for accessing the vehicle in the LF frequency band. An LF radio link is particularly well-suited for estimating the distance between the mobile communication terminal and the vehicle on the basis of the RSSI since, at such radio frequencies, the measurement of the RSSI on the basis of the distance is particularly stable, and there is a mathematical relationship between the RSSI and the distance (at a higher frequency, this RSSI-based distance measurement system is complex since the RF signal propagation phenomenon is more chaotic). The LF radio link between the access fob and the vehicle, which may be used to lock and unlock the vehicle, is thus utilized so as to achieve reliable monitoring of the distance between the user and the vehicle.

The remote control operations for the remote control of the secure function are, for their part, performed by a mobile communication terminal, such as a multifunction mobile telephone belonging to the user. Remote control is ensured with all the ergonomic qualities provided by the mobile communication terminal, thanks in general to a color screen of convenient size and a configurable and user-friendly display. The user's mobile communication terminal is an object that the user normally carries around. The mobile communication terminal may be configured by various applications in order to perform the remote control operations, with the possible updates and evolutions of these applications.

Although the access fob is utilized to locate the user during the remote control of the secure function, the access fob does not require any modification, such as the addition of extra control keys, a screen, etc. The access fob, which is generally dense in terms of commands or the size of which is tending to decrease, is thus not overloaded.

While the access fob contributes to locating the user and his mobile makes it possible to remotely control the secure function, an aspect of the invention guarantees that the access fob and the mobile communication terminal are close to one another and are therefore being carried by the user. The predetermined distance is preferably chosen to be small enough to guarantee that the user is carrying around both the access fob and his mobile communication terminal.

According to one preferred feature of the method, the step of detecting the presence of the mobile communication terminal at a distance less than a predetermined distance from the access fob is performed by detecting, at the access fob, the flashing of a component of the mobile communication terminal.

This feature is particularly advantageous since it does not require the implementation of any additional physical means for communication between the access fob and the mobile communication terminal.

An aspect of the invention thus makes it possible to remotely control a secure motor vehicle function in a user-friendly manner while at the same time guaranteeing, with a high level of security, that the user is present within a security perimeter around the vehicle. The means that are used are relatively non-intrusive in terms of the makeup of the elements usually used in the automotive sector. A common mobile communication terminal along with a conventional access fob may be used without requiring any hardware modification, thereby reducing complexity and costs.

The remote control method may comprise the following additional features, on their own or in combination:
the method comprises: a step of stopping the remote control of the secure function if the access fob is detected outside the security perimeter; and a step of stopping the remote control of the secure function if the mobile communication terminal is detected at a distance greater than said predetermined distance from the access fob;
the step of detecting the presence of the mobile communication terminal at a distance less than a predetermined distance from the access fob is performed by transmitting a binary frame between the mobile communication terminal and the access fob;
the step of detecting the presence of the mobile communication terminal at a distance less than a predetermined distance from the access fob is performed by detecting, at the access fob, the flashing of a component of the mobile communication terminal;
said flashing is flashing of the screen of the mobile communication terminal;
the flashing of the screen is performed through periodic sequences of turning off the screen;
during the periodic sequences of turning off the screen, each instance of turning off the screen lasts less than 42 ms;
the step of detecting the presence of the mobile communication terminal at a distance less than a predetermined distance from the access fob comprises detecting saturation of the LF stage of the access fob;
the method comprises, before the step of detecting the presence of the mobile communication terminal at a distance less than a predetermined distance from the access fob, a step of superimposing the access fob and the mobile communication terminal;
the step of detecting the presence of the mobile communication terminal at a distance less than a predetermined distance from the access fob is performed at the access fob and is followed by a step of transmitting this detection information to the control unit;
the step of remotely controlling, by way of the mobile communication terminal, said secure function of the vehicle on the UHF-SHF frequency band is performed using the Bluetooth communication standard;
the method comprises an initialization step in which the mobile communication terminal transmits initialization data to the access fob, these initialization data for initializing the access fob being transmitted to the control unit.

According to one preferred feature, the LF vehicle access fob comprises detection means for detecting saturation of its LF stage.

The application for a mobile communication terminal may comprise the following additional features, on their own or in combination:
the step of periodically generating a flashing sequence on a component of the mobile communication terminal is performed by periodically generating a sequence of turning off the screen of the mobile communication terminal;
each instance of turning off the screen lasts less than 24 ms;
information is encoded in binary frames during the flashing sequences;
said information encoded in binary frames comprises a pairing code for the mobile communication terminal.

### BRIEF DESCRIPTION OF THE DRAWINGS

Further features and advantages of aspects of the invention will become apparent from the description that is given hereinafter by way of non-limiting example, with reference to the accompanying drawings, in which:

FIG. 1 illustrates a situation of remotely controlling the parking of a vehicle;

FIG. 2 illustrates the communication between a vehicle, a mobile phone and an access fob;

FIG. 3 shows a mobile terminal and an access fob, which are superimposed and seen in a profile view;

FIG. 4 illustrates a communication frame for communication between the mobile telephone and the access fob from FIG. 3;

FIG. 5 illustrates an operation of initializing the communication between the mobile terminal and the access fob from FIG. 3;

FIG. 6 illustrates communication operations between the mobile terminal, the access fob and the vehicle.

### DETAILED DESCRIPTION OF THE PREFERRED EMBODIMENTS

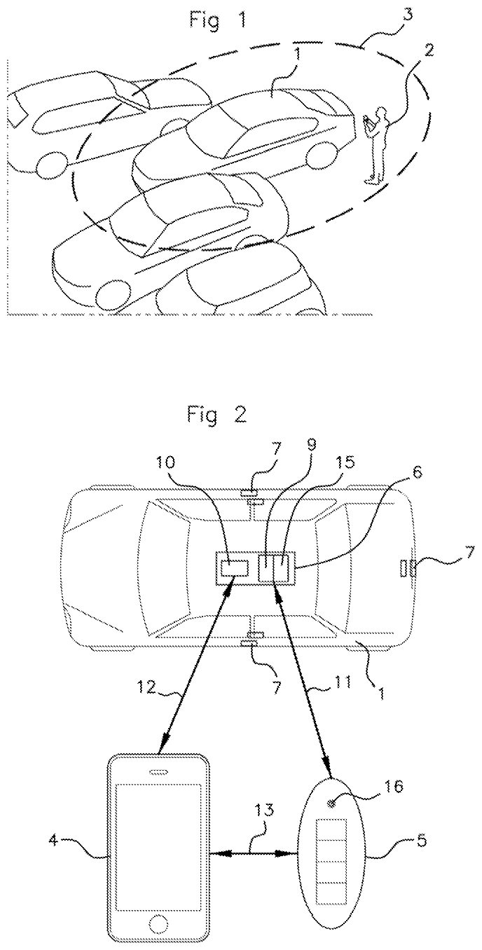

One exemplary implementation of an aspect of the invention will now be described. According to this example, the secure vehicle function that is being remotely controlled is the parking of the vehicle. FIGS. 1 to 6 illustrate various aspects of a method and of a device for remotely controlling the parking of a vehicle, requiring the user to be present within a security perimeter around the vehicle.

FIG. 1 schematically illustrates a situation of a user 2 remotely controlling the parking of a vehicle 1. In this example, the user 2 is outside his vehicle and is remotely controlling the insertion of this vehicle into a location of restricted width. For security reasons, the user 2 has to be located within a security perimeter 3 around the vehicle 1. In the present example, this security perimeter 3 is 6 meters, that is to say that the user 2 has to be at a distance of less than 6 meters from the vehicle 1 in order to be able to actuate the remote control of the parking of the vehicle 1.

To actuate this remote control of the parking of his vehicle 1, the user 2 is carrying around his multifunction mobile 4, along with an access fob 5 for accessing the vehicle 1.

FIG. 2 schematically shows the vehicle 1 along with the mobile terminal 4 and the access fob 5 that the user 2 is carrying around.

The vehicle 1 is equipped with a control unit 6 intended in particular to manage access to the vehicle. Specifically, the vehicle 1 has locks 7 that are able to be locked and unlocked by the control unit 6. The control unit 6 comprises an LF transmitter module 9 designed to communicate with the access fob 5 through low-frequency radio waves (generally around one hundred or so kHz). The LF transmitter module 9 may for this purpose comprise a plurality of antennas arranged at various points of the vehicle 1 (and not shown).

LF communication between a control unit 6 and an access fob 5 is well known. This LF communication allows efficient location of the access fob 5 along with low power consumption of this access fob 5. With regard to their function of controlling access to the vehicle, the LF module 9 and the access fob 5 operate in a known manner. For example, when the control unit 6 detects the presence of the access fob 5 through LF waves, it checks the proximity of the fob 5 and unlocks the doors in response to the manipulation of a door handle.

Many devices for managing access to the vehicle and that operate based on this principle are commonly used in the automotive sector. For example, the access device may be what is called an “RF/LF” device that is common in the automotive sector. In such an RF/LF device, the LF module 9 is designed to transmit to the access fob 5 in LF mode in order to detect and locate the access fob 5, and is also designed to receive information from the access fob 5 in RF mode. “RF” in this case denotes higher-frequency communication (for example greater than 300 MHz, and generally than 433 MHz) allowing a larger data exchange between the control unit 6 and the access fob 5 once the latter has been located.

In any event, the control unit 6 comprises at least this LF module 9 for reliably locating the access fob 5 and estimating the distance between the access fob 5 and the vehicle 1.

In the present example, the control unit 6, with regard to access management, operates like an RF/LF device as described above, and furthermore comprises an RF receiver module 15. The access fob in this example comprises an LF receiver and an RF transmitter. Thus, when intention to unlock the vehicle is detected, the LF module 9 calls on the access fob 5 through an LF transmission. The access fob 5, on its side, measures the received RSSI field level and then transmits this value to the RF receiver module 15 of the control unit 6 in RF mode. The control unit 6 then determines the distance between the access fob 5 and the vehicle 1 based on said value of the RSSI field level.

The operation of the control unit 6 and of the access fob 5, with regard to managing access to the vehicle 1, that is to say locking and unlocking the locks 7, is also known and will not be described in more detail here. LF/RF radio communication between the control unit 6 and the access fob 5 is shown schematically by the double-headed arrow 11 in FIG. 2.

The control unit 6 furthermore comprises a UHF-SHF module 10 intended to communicate with the user's mobile terminal 4. The UHF-SHF module 10 in the present example is a BLE (“Bluetooth Low Energy”) module, and the mobile terminal 4 for its part also has the Bluetooth function. Bluetooth radio communication between the control unit 6 and the mobile terminal 4 is shown schematically by the double-headed arrow 12 in FIG. 2.

In order to remotely control the secure parking function, a dedicated application is installed on the mobile terminal 4. This application provides the user with a control interface and communicates the parking commands issued by the user 2 to the control unit 6 through Bluetooth. The control unit 6 is connected to the on-board digital network of the vehicle and to the other control components controlling the operation of the engine, the transmission, the steering, the brakes and any other component required to implement the remotely controlled secure function.

Provision is furthermore made for communication, shown schematically by the double-headed arrow 13 in FIG. 2, between the mobile terminal 4 and the access fob 5. The purpose of this communication is to ensure that the mobile terminal 4 is close to the access fob 5. Specifically, the access fob 5 is used here as a guarantee that the user carrying this access fob 5 is actually located within the security perimeter 3. The communication 13 makes it possible to ensure the immediate proximity of the mobile terminal 4, and therefore also to ensure the presence of the mobile terminal 4 within the security perimeter 3. To this end, provision is made for detection means for detecting the proximity of the mobile terminal 4 and the access fob 5. Insofar as the control unit 6 is able to communicate both with the mobile terminal 4 and with the access fob 5, the control unit 6 may interrogate one or the other of these elements, or both, in order to request and obtain this proximity check.

The communication 13 between the mobile terminal 4 and the access fob 5 may be performed by any means for detecting the proximity of the two elements.

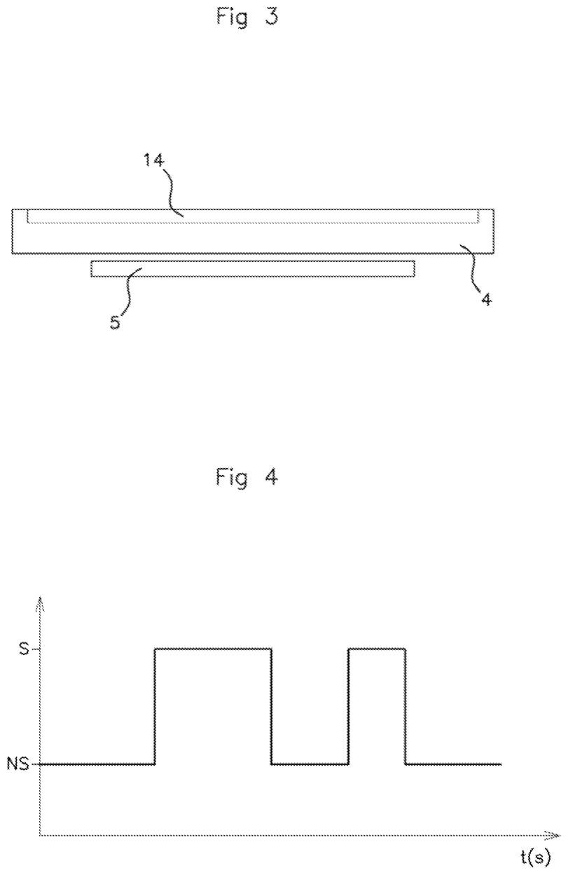

FIG. 3 illustrates one example of communication 13 between the mobile terminal 4 and the access fob 5. In this example, the access fob 5 is a flat fob with the format of a smart card. In the operating mode relating to the example of FIG. 3, when the user is preparing to remotely control the secure function of the vehicle, he superimposes his mobile terminal 4 on the access fob 5, thus holding them together in one hand. FIG. 3 illustrates the mobile terminal 4 and the access fob 5, which are thus superimposed, seen in a profile view. The user interacts with the screen 14 of the mobile terminal 4 with his other hand in order to remotely control the secure function. In this particularly advantageous example, the communication between the mobile terminal 4 and the access fob 5 is performed through flashing of the screen 14.

The particular nature of an LF transmitter or receiver is that it saturates when it is placed very close to a screen, such as an LCD screen. The distance at which the screen 14 of the mobile terminal 4 may saturate the LF stage of the access fob 5 depends in particular on the type of screen that is used, but it is however established that a distance of less than 10 centimeters enables this saturation. A fortiori, when the mobile terminal 4 and the access fob 5 are superimposed as in the example in FIG. 3, saturation of the LF stage of the access fob 5 when the screen 14 is turned on is certain. Thus, by controlling turning on or turning off of the screen 14, it is possible to saturate or not to saturate the LF stage of the access fob 5. Binary information (“saturated state” or “unsaturated state”) may therefore be transmitted between the mobile terminal 4 and the access fob 5 by turning the screen 14 on and off.

However, the screen 14 has to be turned on during the remote control maneuver in order to allow the user to use the interface. To allow communication with the access fob 5 while still allowing the user to see the interface, the screen 14 is kept turned on while being interspersed with turning-off operations, allowing communication between the mobile terminal 4 and the access fob 5. If these turning-off periods are shorter than persistence of vision, these instances of turning off the screen 14 will not be visible to the user and will not generate any discomfort.

According to one embodiment, the communication between the mobile terminal 4 and the access fob 5 may be reduced to a simple periodic check of the presence of the mobile terminal 4 at a short distance from the access fob 5. This short distance corresponds to a distance short enough to allow the LF stage of the access fob 5 to be saturated by the screen 14 of the mobile terminal 4. In this embodiment, the access fob 5 is simply programmed to detect saturation of its LF stage with a predetermined periodicity and, when this saturation is no longer detected, the access fob 5 thus determines that the mobile terminal 4 is no longer close to the access fob 5. The access fob 5 then communicates to the control unit 6 that the presence of the mobile terminal 4 is no longer guaranteed within the security perimeter 3, and the control unit 6 then immediately blocks the secure function, that is to say, in the present example, it stops the parking maneuver. For example, the remote parking application on the mobile terminal 4 is programmed to generate, every second, a sequence of instances of turning off the screen 14, these instances of turning off lasting less than 42 ms. When the access fob 5 does not detect a saturation sequence of its LF stage, corresponding to the sequence of instances of turning off the screen 14, for several seconds, the control unit 6 is informed by the access fob 5 that the mobile terminal 4 is no longer close to the access fob 5.

According to another embodiment, the flashing of the screen 14 may be implemented so as to send more complex information to the access fob 5. With reference to FIG. 4, data may be encoded in binary frames, for example in NRZ (“Non Return to Zero”), through the two possible states of the LF stage of the access fob 5 (saturated S and unsaturated NS) that are controlled by turning the screen 14 on and off. NRZ frames may thus be sent in accordance with any suitable protocol.

Regardless of the embodiment, the access fob 5 comprises a program for detecting saturation or lack of saturation of its LF stage and decoding the NRZ frames formed of these two states.

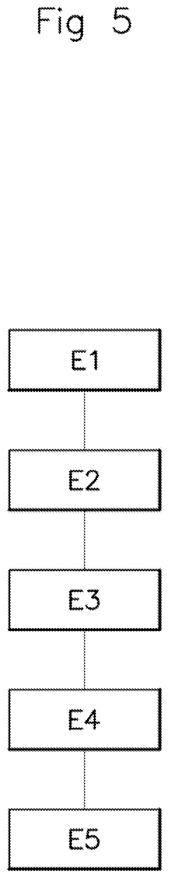

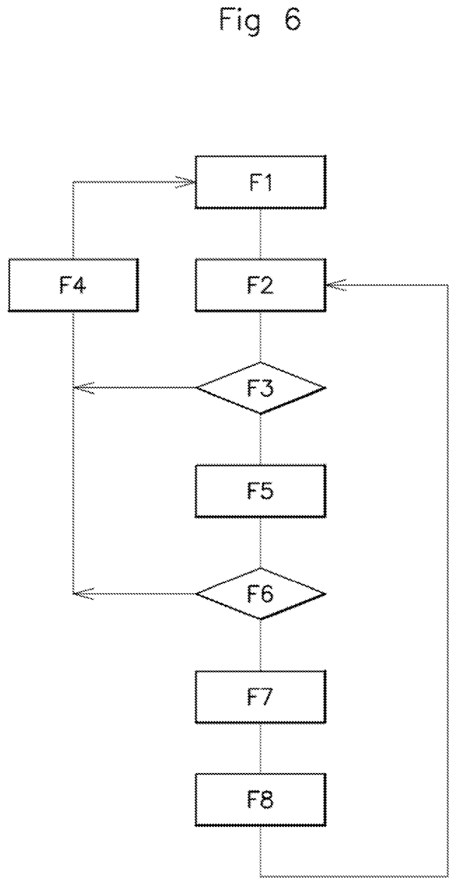

FIGS. 5 and 6 illustrate detailed methods of this embodiment in relation to FIGS. 3 and 4.

FIG. 5 illustrates an initialization operation in which initial data are transmitted from the mobile terminal 4 to the access fob 5, for example in order to configure future exchanges between the mobile terminal 4 and the access fob 5.

In a first step E1, the access fob 5 and the mobile terminal 4 are superimposed.

In a following step E2, an indicator is activated in order to indicate the start of an information transmission. This indicator is for example the flashing of an indicator light 16 on the access fob 5. The user is thus invited to hold the access fob 5 against the mobile terminal 4 throughout the duration of the information transmission.

In a following step E3, the data transmission is performed by switching the screen off and on, the switching-off phases preferably being less than 42 ms so as not to be visible to the user. During this transmission, any initialization data useful for the remote control of the secure function may be transmitted in binary form, for example in NRZ. By way of example, the mobile terminal 4 may transmit its Bluetooth pairing code to the access fob 5.

In a following step E4, the end of the data transmission is indicated, for example, through the stopping of the flashing of the indicator light 16 of the access fob 5.

In a following optional step E5, the initialization data that have been transmitted from the mobile terminal 4 to the access fob 5 may also be transmitted to the control unit 6 of the vehicle. By way of example, if the Bluetooth pairing code was transmitted to the access fob 5 in step E3, this pairing code may then be transmitted, during this step E5, to the control unit 6. This secures the identification of the mobile terminal 4.

FIG. 6 illustrates the remote control of the secure function of the vehicle when the access fob 5 and the mobile terminal 4 are superimposed in the hand of the user who wishes to start the remote control of the parking of his vehicle.

In a first step F1, the user launches the appropriate application on the mobile terminal 4 and requests the remote control procedure for the parking. This request to start the remote control of the secure function is sent from the mobile terminal 4 to the control unit 6 via Bluetooth. During this step, the access fob 5 is in a mode for the periodic wakeup of its LF stage, that is to say that the access fob 5 is in a mode with minimum energy consumption, checking only periodically for the reception of any LF signal from the control unit 6.

In a step F2, the control unit 6, in response to the parking remote control request, requests the location of the access fob 5 from the latter through an LF communication. The access fob 5 is programmed to transmit, in response to this positioning request, a predetermined RF frame in the direction of the control unit 6.

In the following step F3, the control unit 6 checks that the access fob 5 has actually responded to its positioning request and checks, by measuring the RSSI, that this position is actually within the security perimeter.

If the control unit 6 does not receive any response to its request, or if the positioning response indicates positioning of the access fob 5 outside the security perimeter, the method moves to step F4 of stopping the secure function.

If the control unit 6 actually receives, from the access fob 5, the response to its positioning request, and the RSSI measurement indicates that the access fob 5 is actually located within the security perimeter, the method moves to step F5, in which data are transmitted from the mobile terminal 4 to the access fob 5 through flashing of the screen 14 of the mobile terminal 4.

In a following step F6, the access fob 5 determines whether it has actually received the data transmitted through flashing of the screen 14 by detecting the succession of saturated and unsaturated states of its LF stage.

If the access fob 5 does not detect the information transmitted through flashing of the screen 14 of the mobile terminal 4, the method moves to step F4 of stopping the procedure. This means that the access fob 5 is no longer superimposed with the mobile terminal 4.

If the information transmitted through the flashing of the screen 14 is duly received by the access fob 5, the method moves to step F7, where the access fob 5 transmits, to the control unit 6, the information according to which the mobile terminal 4 was detected close to the access fob 5, and is therefore also within the security perimeter 3.

On moving to the following step F8, the control unit 6 has received:
the remote control request from the mobile terminal 4;
the information confirming the presence of the access fob 5 within the security perimeter;
the information confirming the presence of the mobile terminal 4 close to the access fob 5, and therefore within the security perimeter.

In step F8, the control unit 6 therefore authorizes continuation of the remote control of the secure function of the vehicle.

The method then loops back to step F2, so that the checking of the presence of the access fob 5 and of the mobile terminal 4 within the security perimeter is performed continuously during the remote control, the procedure being stopped as soon as one of these elements leaves the security perimeter.

Variant embodiments of the methods and means described above may be contemplated without departing from the scope of the invention. In particular, the mobile communication terminal-based remote control may be implemented for secure functions other than parking the vehicle, as described in the present example. By way of example, this secure function, which requires the user to be present within a security perimeter around the vehicle, may be that of closing or opening the opening elements of the vehicle (doors, trunk, etc.).

Communication from the access fob 5 to the control unit 6 may also be performed by any means other than the “RE” communication described above.

1. A method for the remote control, by way of a mobile communication terminal equipped with a UHF-SHF module, of a secure motor vehicle function requiring a user to be present within a security perimeter around the vehicle, this vehicle being equipped with an access device comprising a control unit and an access fob, the method comprising:
detecting a presence of the access fob within said security perimeter around the vehicle through LF communication between the vehicle and the access fob;
detecting a presence of the mobile communication terminal at a distance less than a predetermined distance from the access fob, by detecting saturation of an LF stage of the access fob (5) performed through flashing of a screen of the mobile communication terminal,
through a communication operation between the access fob and the mobile communication terminal; and
remotely controlling, by way of the mobile communication terminal, said secure function of the vehicle on the UHF-SHF frequency band.

2. The method as claimed in claim 1, further comprising:
stopping the remote control of the secure function if the access fob is detected outside the security perimeter; and
stopping the remote control of the secure function if the mobile communication terminal is detected at a distance greater than said predetermined distance from the access fob.

3. The method as claimed in claim 1, wherein the detecting the presence of the mobile communication terminal at a distance less than a predetermined distance from the access fob is performed by transmitting a binary frame between the mobile communication terminal and the access fob performed through flashing of the screen of the mobile communication terminal.

4. The method as claimed in claim 1, wherein the flashing of the screen is performed through periodic sequences of turning off the screen.

5. The method as claimed in claim 4, wherein, during the periodic sequences of turning off the screen, each instance of turning off the screen lasts less than 42 ms.

6. The method as claimed in claim 1, further comprising, before the detecting the presence of the mobile communication terminal at a distance less than a predetermined distance from the access fob, superimposing the access fob and the mobile communication terminal.

7. The method as claimed in claim 1, wherein the detecting the presence of the mobile communication terminal at a distance less than a predetermined distance from the access fob is performed at the access fob and is followed by a step of transmitting this detection information to the control unit.

8. The method as claimed in claim 1, wherein the remotely controlling, by way of the mobile communication terminal, said secure function of the vehicle on the UHF-SHF frequency band is performed using the Bluetooth communication standard.

9. The method as claimed in claim 1, further comprising an initialization step in which the mobile communication terminal transmits initialization data to the access fob, these initialization data for initializing the access fob being transmitted to the control unit.

10. A device for the remote control of a secure motor vehicle function as claimed in the method of claim 1, the device comprising:
a vehicle control unit designed to control access to the vehicle and comprising an LF transmitter and a UHF-SHF transceiver;
an access fob equipped with an LF receiver and designed to communicate with the vehicle control unit in order to remotely control access to the vehicle;
a mobile communication terminal equipped with a UHF-SHF module designed to communicate with the UHF-SHF transceiver of the vehicle control unit in order to remotely control said secure function of the vehicle, comprising an application programmed to generate flashing of the screen,
the vehicle control unit comprising detection means for detecting the presence of the access fob within said security perimeter around the vehicle; and
the access fob comprising detection means for detecting the presence of the mobile communication terminal at a distance less than said predetermined distance through detection means for detecting saturation of an LF stage of the access fob.

11. An LF vehicle access fob designed to implement the method as claimed in claim 1, comprising communication means for communicating with a mobile communication terminal.

12. An application for a mobile communication terminal, comprising instructions that, when the application is executed by a mobile communication terminal, prompt the latter to implement the following steps:
provide an interface for the remote control of a secure motor vehicle function requiring a user to be present within a security perimeter around the vehicle;
periodically generate a flashing sequence on a component of the mobile communication terminal.

13. The application as claimed in claim 12, wherein the step of periodically generating a flashing sequence on a component of the mobile communication terminal is performed by periodically generating a sequence of turning off the screen of the mobile communication terminal.

14. The application as claimed in claim 13, wherein each instance of turning off the screen lasts less than 24 ms.

15. The application as claimed in claim 12, wherein information is encoded in binary frames during the flashing sequences.

16. The application as claimed in claim 15, wherein said information encoded in binary frames comprises a pairing code for the mobile communication terminal.
